(19) United States
(12) Patent Application Publication
(10) Pub. No.: US 2008/0294455 A1
(43) Pub. Date: Nov. 27, 2008

(54) SYSTEM AND METHOD FOR COMMUNICATING IN A MULTILINGUAL NETWORK

(75) Inventor: Aavishkar Bharara, Delhi (IN)

Correspondence Address: PETER VOGEL;GE HEALTHCARE, 20225 WATER TOWER BLVD., MAIL STOP W492, BROOKFIELD, WI, 53045, US

(73) Assignee: GENERAL ELECTRIC COMPANY, Schenectady, NY (US)

(21) Appl. No.: 11/752,524

(22) Filed: May 23, 2007

(51) Int. Cl. G06Q 50/00

(52) U.S. Cl. 705/2

(57) ABSTRACT

A method of communicating in a multilingual network comprises receiving a request from a user for a medical data, obtaining the medical data from a server unit, wherein the medical data is stored in a first language, identifying a second language based on a predetermined condition and converting the medical data from the first language to the second language.

### FIELD OF INVENTION

The invention relates to systems and methods of communicating over a network. More specifically, the invention relates to interactive systems and methods of communicating over a multilingual network.

### BACKGROUND OF INVENTION

The movement towards globalization needs to take into account basic human elements, such as differences in language. In the medical field, healthcare facilities are typically configured to communicate in a default language based on the location of the healthcare facility. For example, a hospital located in China can be configured to communicate in “Chinese”, while another hospital located in Korea can be configured to communicate in Korean.

One limitation associated with the prior art is absence of direct inter-operability of language translations thereby restricting the level of interaction between multiple healthcare facilities. Thus, the information shared by two healthcare facilities, independent of language barrier, is limited to medical images. This limitation leads to a number of complications in communicating and comprehending patient information.

In one scenario, imaging of a patient is done in a first country, for example, Korea, and a medical staff such as a radiologist, performs an initial diagnosis based on one or more medical images. Further, if the radiologist desires to obtain a second opinion from an expert present in another country, for example, USA, a communication problem arises, as the expert in USA may not be well versed in the Korean language. Thus, the sharing between the radiologist in Korea and the expert in USA is restricted to images and no feedback on initial review can be shared between the two thereby resulting in an interoperability and knowledge sharing loss.

Further to the scenario, the radiologist records an audio dictation in Korean language upon performing the initial diagnosis. The audio dictation is to be converted to text by a transcriptionist. If the transcriptionist is not well versed in Korean language, the audio dictation cannot be transcribed to a report, thereby resulting in an opportunity loss for the healthcare facility that desires to outsource the transcriptionist work to another geological location or another facility where the transcriptionist is not versed in Korean.

In another scenario, a healthcare facility works on multiple shifts and medical staff from various countries work in the healthcare facility. A single desktop cannot be shared by two medical staff desiring to work in two different languages. The desktop with the user interface and the application program are simply not configured to support multiple languages. This results in productivity and infrastructure loss for the healthcare facility.

Hence there exists a need for a system that can be operated to use and display information in multiple languages. There also exists a need for a method to communicate patient information in multiple languages.

### BRIEF DESCRIPTION OF THE INVENTION

The above-mentioned shortcomings, disadvantages and problems are addressed herein which will be understood by reading and understanding the following specification.

In one embodiment, a method of communicating in a multilingual network is provided. The method comprises steps of receiving a request from a user for a medical data, obtaining the medical data from a server unit, the medical data being stored in a first language, identifying a second language based on a predetermined condition and converting the medical data from the first language to the second language.

In another embodiment, a system for communicating in a multilingual network is provided. The system comprises a client unit configured for requesting medical data, a server unit configured for storing the medical data and a multilingual agent coupled to the client unit and the server unit, the multilingual agent being configured for converting the medical data from a first language to a second language.

In yet another embodiment, a computer program product stored in a computer readable media for operating in a multilingual network is provided. The computer program product comprises a routine for obtaining a user access into a client unit by a user via a user interface and a routine for converting the user interface from a first language to a second language.

In another embodiment, a multilingual agent for a multilingual network includes a medical data analyzer, a language identifier and a language conversion engine. The medical data analyzer receives a medical data in a first language from a server unit and breaks the medical data into a plurality of pieces. The language identifier identifies the first language for the medical data. The language conversion engine converts each piece of the medical data from the first language to a second language and provides the medical data in the second language to a client unit.

Systems and methods of varying scope are described herein. In addition to the aspects and advantages described in the summary, further aspects and advantages will become apparent by reference to the drawings and with reference to the detailed description that follows.

### BRIEF DESCRIPTION OF THE DRAWINGS

FIG. 1 shows a schematic diagram depicting a system for communicating in a multilingual network, in one embodiment;

FIG. 2 shows a flow diagram depicting a method of communicating in a multilingual network, in an embodiment;

FIG. 3 shows a flow diagram depicting a method of obtaining a medical data, in an embodiment;

FIG. 4 shows a flow diagram depicting a method of identifying a second language, in an embodiment;

FIG. 5 shows a flow diagram depicting a method of communicating in a multilingual network, in another embodiment;

FIG. 6 shows a flow diagram depicting a method of operating a medical workstation in a multilingual network, in an embodiment;

FIG. 7 shows a flow diagram depicting a method of obtaining a user access, in an embodiment; and

FIG. 8 shows a flow diagram depicting a method of checking for authorization, in an embodiment.

### DETAILED DESCRIPTION OF THE INVENTION

In the following detailed description, reference is made to the accompanying drawings that form a part hereof, and in which is shown by way of illustration specific embodiments, which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

The present application describes a workflow by which various users in a healthcare entity can share information such as medical data, in a language independent way. The medical data relates to data concerning a medical subject. The medical subject refers to an article, an object, a person or an animal. Typically, the medical data comprises a primary medical data and an auxiliary medical data. The primary medical data comprises data that can be collected over the course of diagnosis and treatments. In general the primary medical data includes genetic medical data, medical history, physical handicaps, known medical conditions, known medical allergies, and current ailment conditions such as symptoms, duration, temperature, blood pressure, pulse rate, blood test data, urine test data, physician observations and the like.

Additionally, the primary medical data may include drug data such as prescriptions, allergy information, drug interaction information, drug treatment information, overdose information and diagnostic data such as radiology information, laboratory information, clinical information, computed tomography (CT) images, ultra sound images, magnetic resonance images, X-ray images, laboratory test results, doctor progress notes, details about medical procedures, radiological reports, other specialist reports, demographic information, and/or billing (financial) information. Further the primary medical data includes an object identification data. The object identification data includes general information concerning the medical subject such as identity, age, height, weight, sex, race and family of the medical subject.

The auxiliary medical data comprises data that is derived from the primary medical data. Typical examples of the auxiliary medical data include but are not limited to a voice clip, an aural annotation, a dictation file and/or a diagnostic report. The auxiliary medical data may further include exam notes and/or miscellaneous text data such as sticky notes.

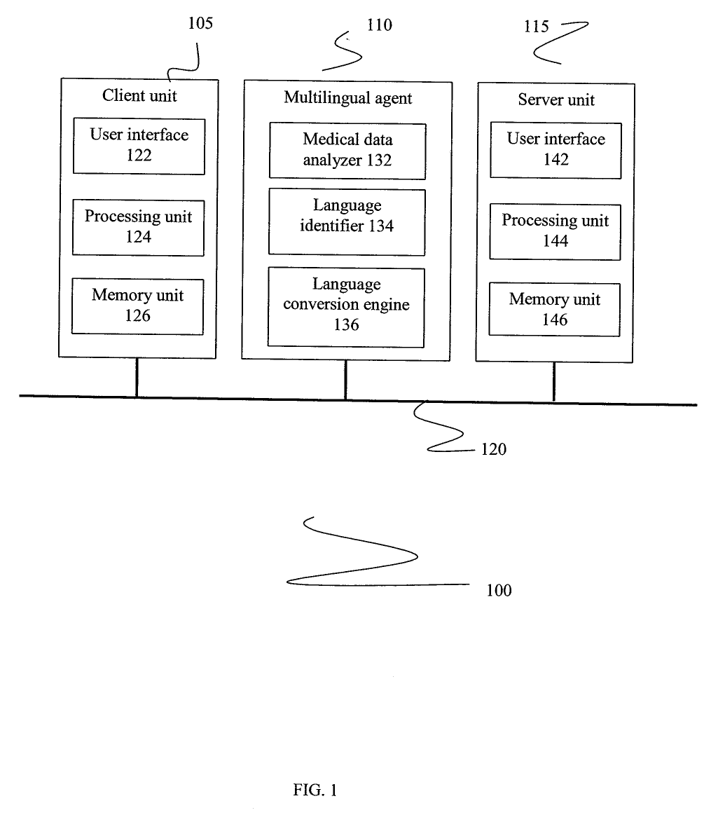

Turning now to the figures, a networked system in which an embodiment of the invention operates is illustrated in FIG. 1. The networked system 100 includes a client unit 105, a server unit 115, and a multilingual agent 110. The client unit 105 can be a medical workstation requesting services (such as access to medical data), and the server unit 115 can be a medical workstation providing services. The medical data for each medical subject may be stored in the server unit 115 in the form of a relational database.

The multilingual agent 110 assists the client unit 105 and the server unit 115 and their users and providers. The multilingual agent 110 may run on the client unit 105, on the server unit 115, or on a separate medical workstation. In FIG. 1, the multilingual agent 110 is shown as running on a separate medical workstation. The client unit 105, the server unit 115, and the medical workstation on which the multilingual agent 110 is running are connected to one another via a network 120. The network 120 in this context may be a LAN, MAN, WAN, intranet, the Internet and/or the WWW.

In one embodiment, the client unit 105 and the server unit 115 are connected to the Internet and are accessing resources (such as medical data) through the Internet. The Internet is a worldwide network 120 in which the medical workstations connected to the network 120 communicate using protocols, such as a Transfer Control Protocol (“TCP”) and an Internet Protocol (“IP”), collectively referred to as “TCP/IP.”

The client unit 105 and the server unit 115 typically include a processing unit 124 and 144 and a memory unit 126 and 146. Additionally, the client unit 105 and the server unit 115 typically are connected to any number of user interfaces 122 and 142 or input/output (“I/O”) devices, such as monitors, keyboards, printing devices, and storage devices. These components of the client unit 105 and the server unit 115 are well known in the art and will not be discussed in greater detail.

For the sake of simplicity, the networked system 100 has been illustrated with a single client unit 105 and a single server unit 115. However, one of ordinary skill in the art will appreciate that the networked system 100 could include any number of client units 105 and any number of server units 115 (and typically, would include a multiple number of client units 105 and a multiple number of server units 115). Each additional client unit 105 and server unit 115 would be connected to the others via the network 120 and would include components similar to those discussed above in connection with the client unit 105 and the server unit 115.

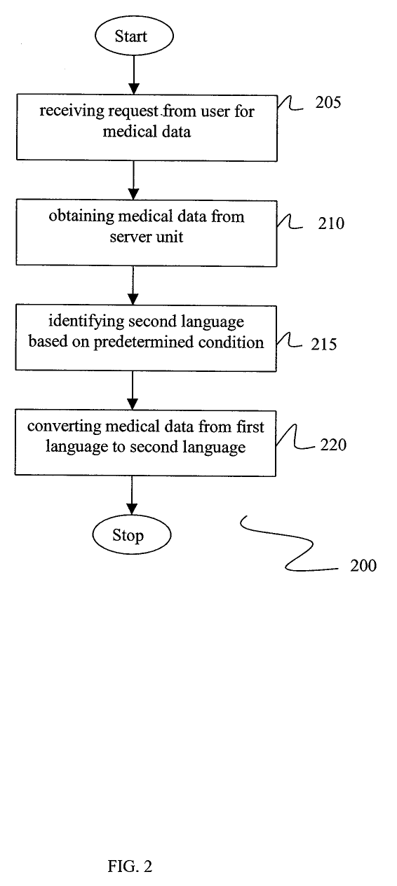

In one embodiment as shown in FIG. 2, a method 200 of communicating in a multilingual network 120 is provided. The method 200 comprises steps of receiving a request from a user for a medical data step 205, obtaining the medical data from the server unit 115 step 210, the medical data being stored in a first language, identifying a second language based on a predetermined condition step 215 and converting the medical data from the first language to the second language step 220.

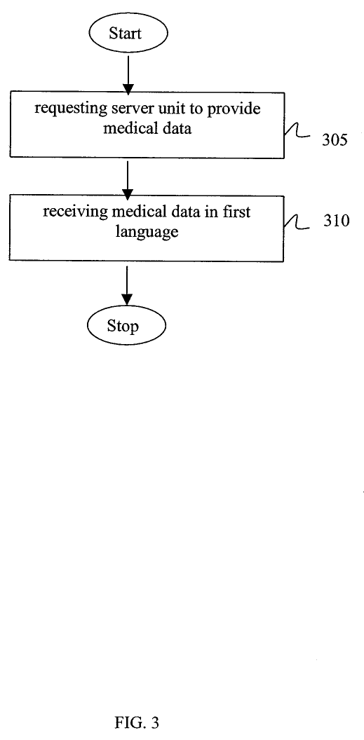

Further, the method of obtaining the medical data step 210, as shown in FIG. 3, comprises requesting the server unit 115 to provide the medical data step 305 and receiving the medical data in the first language step 310.

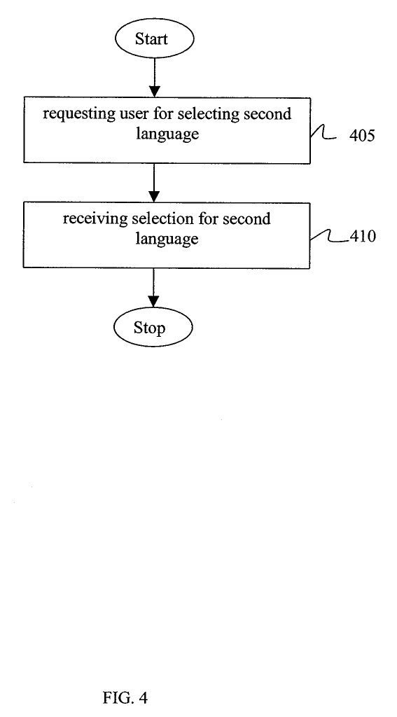

The method of identifying the second language step 215, as shown in FIG. 4, comprises requesting the user for a selection of the second language step 405 and receiving the selection for the second language step 410. Accordingly, the user prior to gaining user access into the client unit 105 can be requested for providing a selection for the second language.

In an alternative embodiment, the location of the client unit 105 through which the user enters the network 120 can be used to identify the language the user wants to communicate in. For example, a user entering the network 120 through the client unit 105 located at Korea may, in most probabilities, desire to communicate in the Korean language. Hence, each client unit 105 can be configured to be sensitive only to the language needs of the user entering the network 120 at its local site.

Thus, the predetermined condition for identifying the second language the user wants to communicate in comprises at least one of a location of the user and a user input. In yet another embodiment, the predetermined condition for identifying the second language comprises a selected language data configured by an operator of client unit 105. For example, an IT administrator for a hospital located in Korea may configure the client unit 105 to communicate in Korean by setting the selected language data to “Korean”.

The multilingual agent 110 assists users in locating, accessing, and understanding the medical data, regardless of the languages in which the medical data are stored. The multilingual agent 110 fetches the medical data from server unit 115 and converts the medical data to the second language. The multilingual agent 110 includes a medical data analyzer 132, a language identifier 134, and a language conversion engine 136.

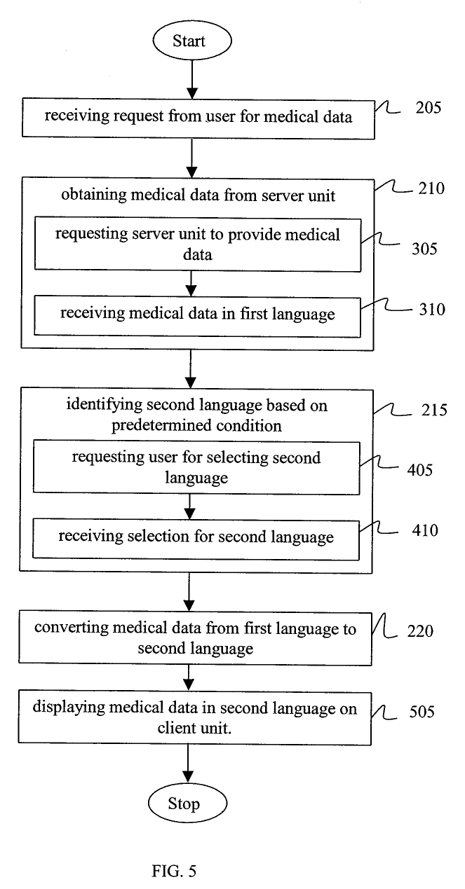

FIG. 5 shows a sequence diagram of communicating the medical data in a multilingual network 120. Initially, the client unit 105 receives a request for fetching the medical data step 205. When the client unit 105 retrieves the medical data from the server unit 115 step 210, the multilingual agent 110 determines whether the medical data is written in a language that is different from the second language selected by the user of the client unit 105 step 215. If the medical data is written in a language that is unfamiliar to the user of the client unit 105, the multilingual agent 110 converts the medical data from the first language to the second language step 220. The multilingual agent 110 then provides the client unit 105 with the medical data in the second language. Lastly, the client unit 105 displays the medical data to the user in the second language step 505. These steps occur automatically without any initiative on the part of the user of the client unit 105 or the medical workstation on which the multilingual agent 110 is running. The multilingual agent 110 is initiated once (such as when the medical workstation on which the multilingual agent 110 is running is started up) and then continues to run and convert the medical data as the medical data are retrieved from the server unit 115.

In an alternative embodiment, the user of the client unit 105 initiates the multilingual agent 110 when the client unit 105 retrieves a medical data that is written in a language that is unfamiliar to the user of the client unit 105. The user of the client unit 105 can initiate the multilingual agent 110 in a variety of ways. For example, the user of the client unit 105 can instruct a browser to call the multilingual agent 110 through a command line. Alternatively, the multilingual agent 110 can be an extension to the browser. An option in this multilingual agent browser extension may include converting the medical data from the first language to the second language. When the user of the client unit 105 selects this option, the browser may be configured to call the multilingual agent 110. Further, the user of the client unit 105 may specify the desired second language when the multilingual agent 110 is initiated.

In yet another alternative embodiment, the multilingual agent 110 can be called upon by selecting a hypertext link. The multilingual agent 110 then retrieves the medical data to which the hypertext link points, translates the medical data, and provides the client unit 105 with the translated medical data. This process occurs automatically once the multilingual agent 110 is running. Therefore, as the user of the client unit 105 follows hypertext links in the medical data, each medical data is translated and the client unit 105 is provided with a translated medical data.

In yet another embodiment, the multilingual agent 110 is a proxy server unit. A proxy server unit is an intermediary server unit through which the client unit 105 and other server units 115 communicate. An option in many browsers allows the user of the client unit 105 to specify the proxy server unit. Once the user of the client unit 105 specifies the proxy server unit, the browser directs any request for a medical data from another server unit 115 through the proxy server unit. The proxy server unit then retrieves the medical data from the other server unit 115 and provides the client unit 105 with the medical data. When the multilingual agent 110 is the proxy server unit, the multilingual agent 110 retrieves the medical data from the other server unit 115 and then determines whether the medical data is written in a language that is unfamiliar to the user of the client unit 105. If the medical data is written in a language that is unfamiliar to the user of the client unit 105, the multilingual agent 110 converts the medical data from the first language to the second language and provides the medical data to the client unit 105. The user interface 122 of the client unit 105 then displays the medical data to the user of the client unit 105.

Further, the step of translating a medical data is explained in greater detail. Initially, the medical data analyzer 132 of the multilingual agent 110 breaks the medical data into pieces. For each piece of the medical data, the language identifier 134 of the multilingual agent 110 identifies the first language in which the piece of the medical data is written. Using the identified first language for each piece of the medical data, the language conversion engine 136 of the multilingual agent 110 converts words or phrases in the piece of the medical data into equivalent words or phrases in the second language in the translated medical data.

Starting with a first element in the medical data, the medical data analyzer 132 determines whether each element is one that indicates a potential change in the content or language of the medical data. If the element is one that indicates a potential change in the content or language of the medical data, the medical data analyzer 132 breaks the medical data at the element. Otherwise, the medical data analyzer 132 does not break the medical data at the element. These steps are repeated for each element in the medical data.

The step of breaking a medical data (or a piece of a medical data) into words or phrases is known as word segmentation. With certain languages (such as English), the multilingual agent 110 accomplishes this step by searching for typical word delimiters, such as white space and certain punctuation, and breaking the piece of the medical data at these delimiters. With other languages (such as Japanese), this step requires a more complex approach involving pattern recognition and grammatical heuristics.

One of ordinary skill in the art will appreciate that the various operations that are performed on the pieces of the medical data may be performed on the medical data as a whole without breaking the medical data into pieces. Alternatively, one of ordinary skill in the art will appreciate that the various operations can be performed only on certain pieces of the medical data, such as headings. In this case, the pieces can be specified by the user of the client unit 105.

Coming to the step of identifying the first language in which a piece of the medical data is written, before operation of the language identifier 134, databases are generated indicating the frequency of certain character sequences in the first language. A database is generated for each potential first language. In order to generate these databases, medical data in each first language are analyzed for the character sequences that occur in the medical data. The databases include these character sequences and their frequency in each first language. Generally, the language identifier 134 determines how many times each character sequence in a piece of the medical data occurs in each first language database and then determines the first language in which the piece of the medical data is most likely written based on the frequency of the occurrences of the character sequences in the piece of the medical data in each first language database. The process is repeated for each character sequence in each piece of the medical data.

Some methods enable users to label medical data or pieces of medical data with information regarding the language in which the medical data or the piece of the medical data is written. If a medical data or a piece of a medical data is labeled with this type of information, the step of identifying the first language in which a piece of the medical data is written simply involves examining this information to identify the first language.

Prior to operation of the language conversion engine 136, databases are generated mapping words or phrases in the first languages to equivalent words or phrases in the second languages. A database is generated for each potential first language to second language combination. The database for each combination includes words or phrases in the first language and their equivalent words or phrases in the second language. Additionally, databases are generated listing words or phrases in the second languages. A database is generated for each potential second language. Generally, the multilingual agent 110 breaks a piece of the medical data into words or phrases, identifies the first language, determines the equivalent word(s) or phrase(s) in the second language for each word or phrase in the piece of an original medical data, the original medical data being the medical data in the first language, and then inserts the equivalent word(s) or phrase(s) in the second language for each word or phrase in the piece of the original medical data in a translated medical data, the translated medical data being the medical data in the second language. These steps are repeated for each word or phrase in each piece of the medical data.

If there is more than one equivalent word or phrase in the second language for a word or phrase in a piece of the original medical data, the equivalent words or phrases are displayed in parentheses to indicate that they are all equivalents of one word or phrase in the piece of the original medical data. Conversely, if there is no equivalent word or phrase in the second language for a word or phrase in a piece of the original medical data, an indication of the omission of an equivalent word or phrase is displayed in place of the equivalent word or phrase.

If a word or phrase in a piece of the medical data is not found in the appropriate first language to second language database, the language conversion engine 136 normalizes the word or phrase and then determines the equivalent word(s) or phrase(s) in the second language of the normalized word or phrase (from the appropriate first language to second language database). Many techniques can be used to normalize a word or phrase. For example, normalization of a word may involve changing upper case letters in the word to lower case, removing a suffix from the word, breaking the word into two or more pieces, or restoring accents in the word. The purpose of normalization is to place the word or phrase in a form in which it is stored and thus, will be found, in the first language to second language database. This step may be repeated for different normalizations or variations of the word or phrase.

If a word or phrase in a piece of the medical data is not found, and none of its normalizations or variations are found, in the appropriate first language to second language database, the language conversion engine 136 may take other steps in an attempt to determine the equivalent word(s) or phrase(s) in the second language of the word or phrase in the piece of the medical data. For example, the language conversion engine 136 may determine whether the word or phrase is listed in the appropriate second language database (and, thus, is already in the second language).

If all attempts to determine the equivalent word(s) or phrase(s) in the second language of a word or phrase in a piece of the medical data fail, the language conversion engine 136 inserts an indication of the omission-of an equivalent word(s) or phrase(s) in the second language for the word or phrase in the piece of the medical data in the translated medical data. For example, the language conversion engine 136 may insert the word or phrase in the piece of the medical data itself, an ellipsis, or a phonetic or transliterated string in the translated medical data. The decision whether to insert the word or phrase in the piece of the medical data or some alternative (such as an ellipsis or a phonetic or transliterated string) depends on the similarity between the first language and the second language.

If the first and second languages are similar, the insertion of the word or phrase in the piece of the medical data in the translated medical data may help the user better understand the translated medical data. For example, if the first language is French and the second language is English, the insertion of the word or phrase in the piece of the medical data (in French) in the translated medical data may help the user better understand the translated medical data (in English). Thus, the word or phrase in the piece of the medical data (in French) may be inserted in the translated medical data. However, if the first and second languages are not similar, the insertion of the word or phrase in the piece of the medical data in the translated medical data is not likely to help the user better understand the translated medical data. For example, if the first language is Japanese and the second language is English, the insertion of the word or phrase in the piece of the medical data (in Japanese) in the translated medical data is not likely to help the user better understand the translated medical data (in English). Thus, an ellipsis would be inserted in the translated medical data. In the case where the first and second languages are not entirely similar or dissimilar, the insertion of a phonetic or transliterated string may help the user better understand the translated medical data and, thus, may be inserted in the translated medical data.

One of ordinary skill in the art will appreciate that many other language processing techniques can be used to determine the equivalent word(s) or phrase(s) in the second language of the word or phrase in the piece of the medical data. These techniques include pattern recognition, part-of-speech tagging, lexical lookup, morphological analysis, syntactic analysis, semantic analysis, and statistical methods.

The translated medical data is separated into sections with each section corresponding to a different piece of the original medical data. For each piece of the original medical data, the corresponding section of the translated medical data includes the words or phrases in the piece of the original medical data followed by an indication of the language in which that piece of the original medical data is written and the equivalent words or phrases in the second language for the words or phrases in the piece of the original medical data. Within each section of the translated medical data, the language of the piece of the original medical data is used. As a result, to the extent possible, the language of the translated medical data follows the language of the original medical data and, thus, preserves the intended presentation of the original medical data.

In an optional embodiment, the user interface 122 of the client unit 105 may be configured to give an indication to the user that the medical data has been converted from the first language to the second language. Further, the indication can act as a disclaimer message as well. This being an optional interface, the indication can be turned on or off by a service provider based on user preferences.

In an alternative embodiment, the medical data stored in the server unit 115 can be in Unicode or in a predetermined language. The Unicode language is a compromise by which multiple units in the network 120 such as the server unit 115, the client unit 105 and the multilingual agent 110, can agree on a common language to be used. The Unicode language is the most universally understood language in the context of the network with the most universally supported character set.

The medical data stored in the Unicode language comprises the essential ingredients for constructing the medical data in a second language except the language text. The medical data stored in Unicode language comprises several fixed length fields followed optionally by fields describing values that are to be substituted for the variables in the medical data.

The Unicode of the medical data is converted into the second language by the multilingual agent 110, and subsequently displayed to the user of the client unit 105. The translation is accomplished in accordance with at least one of Universal Character Set and Unicode encoding.

In another embodiment, the medical data can be converted to a selected number of predetermined second languages such as English, French etc, and stored in language specific files. Multiple healthcare facilities can fetch the desired medical data from selected language specific files. Further, the client unit 105 can be configured to store incremental information in the language specific files.

As described above, other aspects of the multilingual agent 110 assist the client units 105 and users of the client units 105 in locating and accessing the medical data on the server units 115 and also assist server units 115 and providers of the server units 115 in making the medical data on the server units 115 available to the client units 105 and users of the client units 105, regardless of the languages in which the medical data are written.

In one embodiment, the medical data can be stored in the server unit 115 in one of a text format, audio format, frequency format and waveform format. The auxiliary medical data comprising annotations, reports, dictation clips is generally stored in the audio format. The auxiliary medical data may be entered using a voice dictation system. The voice dictation system is a system for recording voices or voice data, for example a voice dictation device or a speech recognition system. The voice dictation system may use either digital dictation software (saved audio that will be transcribed at a later time) or real time speech recognition. The speech input may be a microphone, recording device, telephone, or other such device capable of transmitting the acoustic spectrum of speech, either as an analog or digital signal.

The multilingual agent 110 can be configured to convert the medical data comprising the auxiliary medical data in the audio format from the first language to the second language. Accordingly, the multilingual agent 110 includes a speech input device, a speech recognizer, a speech generator and a speech output device. The speech input device stores the inputted speech after an analog-to-digital (A/D) conversion into, for example, a memory unit.

The speech recognizer, used to identify the first language, is then actuated. The speech recognizer reads speech data stored in the memory unit, converts that speech data into a characteristic vector sequence, performs collation using a sentence dictionary having the characteristic vector sequence of each spoken sentence, thereby recognizes the speech data, and outputs the recognition candidates. Other methods for speech recognition may also be used.

The language conversion engine 136 in the multilingual agent 110, using the table for language conversion, converts a character string stored in the first language on the memory unit into the second language.

The speech generator in the multilingual agent 110 is then actuated. The speech generator reads a character string stored in the second language in the memory unit, converts the character string into synthesized speech, and stores waveform data into the memory unit. The waveform data of the speech is converted into analog data by digital-to-analog (D/A) conversion, and the analog data is sent to the client unit 105 via the speech output device as speech.

It will additionally be apparent to those skilled in the art that a speech model matching each first language to a second language may be created and stored onto the memory unit, in a compressed form, in advance of use.

In another embodiment, the multilingual agent 110 includes a speech recognition circuitry and a speech synthesizer. The speech recognition circuitry is connected to the audio output of an electronic device such as a microphone, recording device, telephone, or other such device. The speech recognition circuitry is capable of receiving continuous speech information and converting the speech into machine recognizable phonemes recognized by the speech synthesizer. Phonemes represent the basic elements of speech, which make up words in spoken languages. The speech recognition circuitry also includes a spectrum analyzer 132 to remove background noise.

The language identifier 134 of the multilingual agent 110 receives and stores the phonemes output by the speech recognition circuitry. The phonemes are combined in consecutive order until recognizable words are formed. The language identifier 134 includes a table of recognizable words in a specified number of first languages, wherein each word is identified by a consecutive number of phonemes.

The language identifier 134 attempts to group the sequentially received phonemes in various patterns until a predetermined number of consecutive recognizable words are formed. Ideally, each grouping pattern forms a word and includes a number of consecutive phonemes grouped from a first phoneme to a last phoneme such that a phoneme preceding the first phoneme of that word forms the end of the preceding word and the phoneme following the last phoneme of that word forms the beginning of the following word. The first language of the speech is determined by identifying the language to which those words belong.

After determining the first language of the medical data and combining the consecutively received phonemes into particular groups to form consecutive words, these words are then combined into recognizable sentences in accordance with the grammatical rules of the first language. These recognizable sentences are then received by the language conversion engine 136. The language conversion engine 136 then translates from the first language to the second language, as identified by the second language selection, by the user. The rules associated with the second language are then used to determine the set of language specific voice fragments to retrieve from the particular language specific database for playback to the user. Using this approach requires a separate language specific database for each second language and a corresponding set of rules stored in the system database. Further, the speech synthesizer may be used to broadcast the medical data in the second language selected by the user.

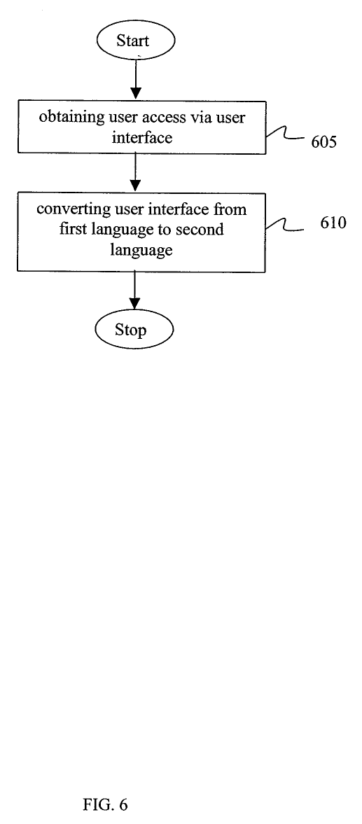

In yet another embodiment, a computer program product stored in a computer readable media for operating a medical workstation in multiple languages is provided. As shown in FIG. 6, the computer program product comprises a routine for obtaining user access to the client unit 105 by a user via the user interface 122 step 605 and a routine for converting the user interface 122 from a first language to a second language step 610.

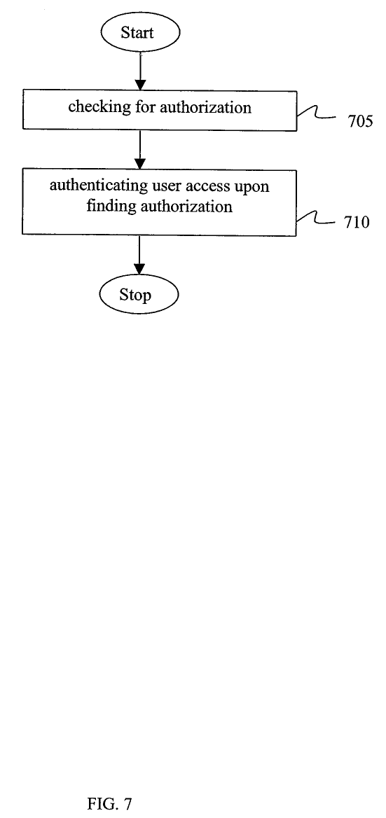

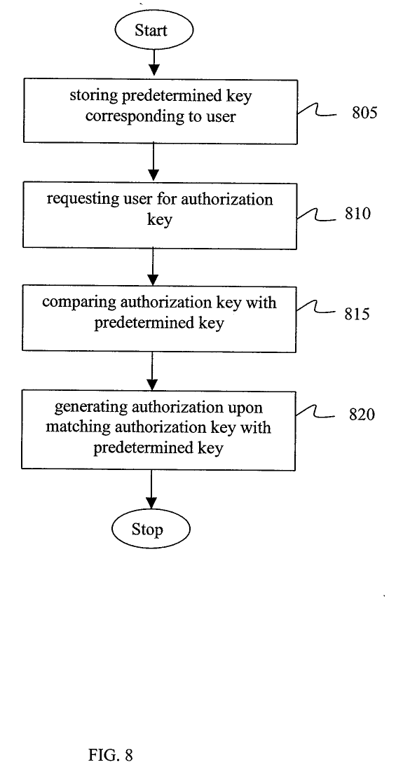

As shown in FIG. 7, the routine for obtaining the user access step 605 comprises a routine for checking for authorization step 705 and a routine for authenticating the user access upon finding authorization step 710. The client unit 105 upon receiving the request for user access checks for the authorization for the user of the client unit 105. FIG. 8 shows the sequence diagram depicting the method of checking for authorization. Each client unit 105 in the networked system 100 is configured to store a predetermined key corresponding to each user of the client unit 105 step 805. The client unit 105 in the process of checking for authorization requests the user for providing an authentication key step 810. The authentication key and the predetermined key may be character strings comprising at least one predetermined character. The predetermined character may include numerical, alphabetic, alphanumeric and other characters and symbols, conventional or arbitrary, as may be desired. Upon matching the authentication key with the predetermined key step 815, an authorization is generated if the predetermined key matches the authentication key step 820.

Accordingly, the computer program product comprises a routine for storing a predetermined key corresponding to the user in the memory unit 126 of the client unit 105 step 805. Further, the routine for checking for authorization step 705 comprises a routine for requesting the user for an authorization key step 810, a routine for comparing the authorization key with the predetermined key step 815 and a routine for generating an authorization upon matching the authorization key with the predetermined key step 820.

Subsequent to the user entering a logon sequence into the client unit 105, the user may be enabled to select the language he or she wants the client unit 105 to use for his or her session. Thus, the computer program product further comprises a routine for requesting the user for selecting a second language and a routine for receiving a selection for the second language.

Once the client unit 105 authenticates the user access, the user interface 122 for the client unit 105 displays a menu in a first language (default language of the client unit 105). The user can then select the second language using options on the menu.

When the user interface 122 gets control as the user has made a selection of the second language, the user interface 122 checks whether the user has changed the language. If so, the user interface 122 stores a number, which identifies the second language. The second language is then used to display the menu in a subsequent user login.

As described above, each of the client unit 105, the server unit 115 and the multilingual agent 110 can be a medical workstation or a desktop computer running an application program whose function is to check database commands for syntax and put them into internal form for a database manager. The processing unit 124 and the memory unit of 126 each client unit 105 enable the execution of the application program.

In one embodiment, subsequent to the user selecting the second language, the user interface 122 and the application program can be converted to the second language. Thus, a single operating system with a single user interface and a single application program can be used by multiple users communicating in one or more languages.

A higher level of complexity occurs in the client unit 105, which supports multiple users simultaneously. The client unit 105 is enabled for a plurality of second languages for use by multiple users in choosing one of the plurality of second languages for communication. In this case the application program is configured to keep track of which language to use for each user, and the memory unit 126 is configured to store multiple numbers, each number identifying the second language used by a single user.

The computer program product further comprises a routine for receiving a request from the user for a medical data and a routine for obtaining the medical data from the server unit 115. The routine for obtaining the medical data comprises, a routine for requesting the server unit 115 to provide the medical data and a routine for receiving the medical data in the first language. The computer program product further comprises a routine for identifying a second language based on the predetermined condition, a routine for converting the medical data from the first language to the second language and a routine for displaying the medical data in the second language on the client unit 105.

The computer program product can be a tangible record in one or more of a printed document, a computer floppy disk, a computer CD-ROM disk, or any other desired medium. The computer program product can be stored in a computer readable medium, such as a floppy disk, a CD-ROM disk, a removable disk and other computer readable files.

It is to be understood that the embodiments described herein may be implemented in various forms of hardware, software, firmware, special purpose processors, or combinations thereof. In one exemplary embodiment, methods described herein are implemented in software as an application comprising program instructions that are tangibly embodied on one or more program storage devices (e.g., hard disk, magnetic floppy disk, RAM, CD Rom, DVD, ROM and flash memory), and executable by any device or machine comprising suitable architecture. It is to be further understood that because the constituent method steps depicted in the accompanying Figures can be implemented in software, the actual flow of the process steps may differ depending upon the manner in which the application is programmed. Given the teachings herein, one of ordinary skill in the related art will be able to contemplate these and similar implementations or configurations of the invention.

Further, the method 200 may be readily implemented in the form of computer software instructions executed by a system in a medical facility. The system may be a computer, an imaging modality such as an ultrasound system, a computed tomography system, a magnetic resonance imaging system and an X ray system, an imaging server unit, a medical information system such as a laboratory information system (LIS), a clinical information system (CIS), a radiology information system (RIS) and a picture archival and communication system (PACS), and the like.

As described in various embodiments, the invention enables a language conversion across different healthcare entities thereby enabling various users to access and comprehend medical data. Further, in one embodiment, the method provides inter operability between various medical information systems such as PACS, RIS, CIS in a language independent way.

A multiple language capability in a medical workstation offers numerous advantages with regard to product marketability in the international sector. For example, a single version of the medical workstation, which provides visual presentations of medical data in multiple languages, can be sold in many different countries.

The method for providing multi lingual support in a networking product, such as a medical workstation that is described in various embodiments is aimed at optimizing the user-friendliness of the medical workstation for the end users. Further, the method is an automated process thereby avoiding the need for a language specialist to carry out the language translation.

A healthcare system configured to communicate independent of languages enables a user such as a medical staff to receive and comprehend medial data in his desired language although the medical data is being stored in the server unit in another language. This takes out the burden from the medical staff about the language incompatibility.

The medical data upon being converted into a second language can be transferred, using an external data storage device such as a digital video disk (DVD) and/or a compact disk (CD), from one medical facility to one or more medical facilities not equipped with a multilingual agent.

As described in one embodiment, a single operating system comprising a single user interface and a single application program can be used by multiple users communicating in one or more languages.

In various embodiments, system and method for communicating in a multilingual network are described. However, the embodiments are not limited and may be implemented in connection with different applications. The application of the invention can be extended to other areas, for example area of educational or corporate training systems. The invention provides a broad concept of communicating a medical data in a multilingual network which can be adapted in any medical institution, such as a hospital, clinic, research facility, university, pharmaceutical company, governmental organization and the like. Accordingly, the invention is not limited to a hospital setting. The design can be carried further and implemented in various forms and specifications.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method of communicating in a multilingual network, the method comprising:
receiving a request from a user for a medical data;
obtaining the medical data from a server unit, wherein the medical data is stored in a first language;
identifying a second language based on a predetermined condition; and
converting the medical data from the first language to the second language.

2. The method of claim 1, wherein the predetermined condition comprises at least one of a location of a user and a user input.

3. The method of claim 1, wherein the second language comprises a predetermined language.

4. The method of claim 1, wherein obtaining the medical data comprises:
requesting the server unit to provide the medical data; and
receiving the medical data in the first language.

5. The method of claim 1, wherein identifying the second language comprises:
requesting the user for a selection of the second language; and
receiving the selection for the second language.

6. The method of claim 1, further comprising displaying the medical data in the second language on a client unit.

7. The method of claim 6, further comprising receiving a second medical data from the client unit after displaying the medical data on the client unit, and converting the second medical data from the second language to the first language.

8. The method of claim 1, wherein the medical data is stored in one of an audio format, a text format, a waveform format and a frequency format.

9. A system for communicating in a multilingual network, the system comprising:
a client unit configured for requesting a medical data;
a server unit configured for storing the medical data; and
a multilingual agent coupled to the client unit and the server unit, the multilingual agent configured for converting the medical data from a first language to a second language.

10. The system of claim 9, wherein the first language is a Unicode language.

11. The system of claim 9, wherein the first language is a predetermined language.

12. The system of claim 9, wherein the medical data is stored in one of an audio format, a text format, a waveform format and a frequency format.

13. A computer program product stored in a computer readable media for operating in a multilingual network, the computer program product comprising:
a routine for obtaining a user access to a client unit by a user via a user interface; and
a routine for converting the user interface from a first language to a second language.

14. The computer program product of claim 13, further comprising:
a routine for checking for authorization; and
a routine for authenticating the user access upon finding authorization.

15. The computer program product of claim 14, further comprising a routine for storing a predetermined key corresponding to the user.

16. The computer program product of claim 15, wherein the routine for checking for authorization comprises:
a routine for requesting the user for an authorization key;
a routine for comparing the authorization key with the predetermined key; and
a routine for generating an authorization upon matching the authorization key with the predetermined key.

17. The computer program product of claim 13, further comprising:
a routine for receiving a request from the user for a medical data;
a routine for obtaining the medical data from a server unit, the medical data being stored in a first language;
a routine for identifying a second language based on a predetermined condition; and
a routine for converting the medical data from the first language to the second language.

18. The computer program product of claim 17, wherein the routine for identifying the second language comprises:
a routine for requesting the user for a selection of the second language; and
a routine for receiving the selection for the second language.

19. The computer program product of claim 18, further comprising a routine for displaying the medical data in the second language on the client unit.

20. The computer program product of claim 17, wherein the predetermined condition comprises at least one of a location of a user and a user input.

21. The computer program product of claim 17, wherein the second language comprises a predetermined language.

22. The computer program product of claim 17, wherein the routine for obtaining the medical data comprises:
a routine for requesting the server unit to provide the medical data; and
a routine for receiving the medical data in the first language.

23. The computer program product of claim 17, wherein the medical data is stored in one of an audio format, a text format, a waveform format and a frequency format.

24. A multilingual agent for a multilingual medical network, comprising:
a medical data analyzer for receiving a medical data in a first language from a server unit and for breaking the medical data into a plurality of pieces;
a language identifier for identifying the first language for the medical data; and
a language conversion engine for converting each piece of the medical data from the first language to a second language and for providing the medical data in the second language to a client unit.
